(19) United States
(12) Patent Application Publication
(10) Pub. No.: US 2019/0293129 A1
(43) Pub. Date: Sep. 26, 2019

(54) FRICTIONAL COUPLING DEVICE OF VEHICULAR POWER TRANSMITTING SYSTEM

(71) Applicant: TOYOTA JIDOSHA KABUSHIKI KAISHA, Toyota-shi (JP)

(72) Inventor: Junichi NISHINOSONO, Nagakute-shi (JP)

(73) Assignee: TOYOTA JIDOSHA KABUSHIKI KAISHA, Toyota-shi (JP)

(21) Appl. No.: 16/361,321

(22) Filed: Mar. 22, 2019

(30) Foreign Application Priority Data
Mar. 22, 2018 (JP) 2018-055341

(51) Int. Cl. F16D 25/0638; F16D 25/12; F16D 1/10

(52) U.S. Cl. CPC F16D 25/0638; F16D 25/12; F16H 2045/0284; F16D 2300/12; F16D 1/10

(57) ABSTRACT

In a frictional coupling device of a vehicular power transmitting system, includes: first and second rotary members; a frictional coupling portion, and a piston disposed movably in a direction of the axis to press the frictional coupling portion, a spacing distance between adjacent spline teeth of the radially outer splined portion in a rotating direction thereof decreases along the direction of the axis in which the friction discs are brought into the spline engagement with the radially outer splined portion during assembling of the friction discs with respect to the first rotary member, and/or a spacing distance between adjacent spline teeth of the radially inner splined portion in a rotating direction thereof decreases along the direction of the axis in which the friction plates are brought into the spline engagement with the radially inner splined portion during assembling of the friction plates with respect to the second rotary member.

This application claims priority from Japanese Patent Application No. 2018-055341 filed on Mar. 22, 2018, the disclosure of which is herein incorporated by reference in its entirety.

### FIELD OF THE INVENTION

The present invention relates to a frictional coupling device provided in a vehicular power transmitting system disposed between a vehicle drive power source and drive wheels.

### BACKGROUND OF THE INVENTION

There is well known a power transmitting system of a vehicle, which is disposed in a power transmitting path between a vehicle drive power source and drive wheels of the vehicle, and which includes a frictional coupling device configured to selectively place a power transmitting path between rotary members, in a power transmitting state and a power non-transmitting state. JP2015-194185A discloses an example of a frictional coupling device in the form of a lock-up clutch 9 which is incorporated in a torque converter 3 and disposed between a front cover 5 and a damper device 10.

The lock-up clutch 9 includes a plurality of external friction plates 91a splined to an inner circumferential surface of a clutch drum 91, a plurality of internal friction plates 92a splined to an outer circumferential surface of a clutch hub 92, and a piston 94 for pressing the external friction plates 91a and the internal friction plates 92a against each other. The external friction plates 91a and the internal friction plates 92a are brought into pressing engagement with each other by a movement of the piston 94 toward the friction plates 91a and 92a.

By the way, there is a risk of generation of a considerable sound of collision of the internal friction plates 92a and the clutch hub 92 against each other upon reduction or elimination of a circumferential backlash therebetween in their circumferential or rotating direction while the external friction plates 91a and the internal friction plates 92a are held in pressing engagement with each other. In this respect, reduction of an amount of the circumferential backlash makes it possible to reduce the generated sound of collision. If the amount of the circumferential backlash is excessively reduced, however, a risk of deterioration of ease of assembling of the internal friction plates 92a with respect to the clutch hub 92 is undesirably increased. The frictional coupling device is not only the lock-up clutch incorporated in the torque converter, but may be provided in a forward/reverse switching device provided in a belt-and-pulley type continuously variable transmission, or in a step-variable transmission, for example. In these latter cases, too, the frictional coupling device suffers from the problem as described above.

### SUMMARY OF THE INVENTION

The present invention was made in view of the background art described above. It is therefore an object of the present invention to provide a frictional coupling device of a vehicular power transmitting system, which permits reduction of a sound of collision due to a circumferential backlash present in the frictional coupling device, while reducing the risk of deterioration of ease of its assembling.

The object indicated above is achieved according to the following modes of the present invention:

According to a first mode of the invention, there is provided a frictional coupling device of a vehicular power transmitting system, comprising: a first rotary member disposed rotatably about an axis; a second rotary member disposed rotatably about the axis; a frictional coupling portion disposed between the first and second rotary members, and including a plurality of friction discs held in spline engagement with spline teeth of a radially outer splined portion formed on an outer circumferential surface of the first rotary member, and a plurality of friction plates held in spline engagement with spline teeth of a radially inner splined portion formed on an inner circumferential surface of the second rotary member, wherein the friction discs and the friction plates are alternately disposed adjacent to each other; and a piston disposed movably in a direction of the axis toward the frictional coupling portion, to press the frictional coupling portion, and wherein a spacing distance between the adjacent spline teeth of the radially outer splined portion in a rotating direction thereof decreases along the direction of the axis in which the friction discs are brought into the spline engagement with the radially outer splined portion during assembling of the friction discs with respect to the first rotary member, and/or a spacing distance between the adjacent spline teeth of the radially inner splined portion in a rotating direction thereof decreases along the direction of the axis in which the friction plates are brought into the spline engagement with the radially inner splined portion during assembling of the friction plates with respect to the second rotary member.

In a second mode of the invention, the frictional coupling device according to the first mode of the invention is configured such that the spacing distance between the adjacent spline teeth of the radially outer splined portion in the rotating direction thereof decreases along the direction of the axis in which the friction discs are brought into the spline engagement with the radially outer splined portion during assembling of the friction discs with respect to the first rotary member, and the direction in which the friction discs are axially brought into the spline engagement with the radially outer splined portion during assembling of the friction discs with respect to the first rotary member is the same as a direction in which the frictional coupling portion is pressed by the piston.

In a third mode of the invention, the frictional coupling device according to the second mode of the invention further comprises a cushion spring which is disposed on one side of the frictional coupling portion remote from the piston, and which generates a biasing force for moving the frictional coupling portion toward the piston.

In a fourth mode of the invention, the frictional coupling device according to the third mode of the invention is configured such that an amount of circumferential backlash in the rotating direction of the radially outer splined portion, which exists between the spline teeth of the radially outer splined portion and radially inner teeth of one of the friction discs which is located furthest from the piston in a direction of the axis, is determined to be zero, when the frictional coupling portion is placed in an engaged state.

According to one aspect of the frictional coupling device according to the first mode of the invention, the spacing distance between the adjacent spline teeth of the radially outer splined portion in the rotating direction decreases in the direction of the axis in which the friction discs are brought into the spline engagement with the radially outer splined portion during assembling of the friction discs with respect to the first rotary member. According to this aspect of the invention, an amount of circumferential backlash in a rotating direction of the first rotary member and existing between the spline teeth of the radially outer splined portion and the first friction disc which is first brought into the spline engagement with the radially outer splined portion in the direction of the axis is small enough to reduce a sound of collision of the friction discs against the spline teeth, which is generated upon elimination of the circumferential backlash between the friction discs and the spline teeth in the rotating direction of the first rotary member when the direction of transmission of a vehicle drive torque to the frictional coupling device is reversed in an engaged state of the frictional coupling portion. On the other hand, reduction of the circumferential backlash between the friction discs and the spline teeth of the radially outer splined portion results in a risk of deterioration of ease of assembling of the friction discs with respect to the first rotary member.

However, the spacing interval between the adjacent spline teeth of the radially outer splined portion in the rotating direction thereof decreases in the direction of the axis in which the friction discs are brought into the spline engagement with the radially outer splined portion during assembling of the friction discs with respect to the first rotary member. Accordingly, the friction discs are brought into the spline engagement with the radially outer splined portion during assembling of the friction discs with respect to the first rotary member, in the direction of the axis from one axial end of the radially outer splined portion at which the spacing interval is the largest, toward the other axial end. The largest spacing interval at the above-indicated axial end of the radially outer splined portion provides a gap between the friction discs and the spline teeth at the above-indicated axial end, which is large enough to permit easy assembling of the friction discs with respect to the first rotary member.

According to another aspect of the frictional coupling device according to the first mode of the invention, the spacing distance between the adjacent spline teeth of the radially inner splined portion in the rotating direction decreases in the direction of the axis in which the friction plates are brought into the spline engagement with the radially inner splined portion during assembling of the friction plates with respect to the second rotary member. According to this aspect of the invention, an amount of circumferential backlash in a rotating direction of the second rotary member and existing between the spline teeth of the radially inner splined portion and the first friction plate, which is first brought into the spline engagement with the radially inner splined portion in the direction of the axis is small enough to reduce a sound of collision of the friction plates against the spline teeth, which is generated upon elimination of the circumferential backlash between the friction plates and the spline teeth in the rotating direction of the second rotary member when the direction of transmission of a vehicle drive torque to the frictional coupling device is reversed in an engaged state of the frictional coupling portion. On the other hand, reduction of the circumferential backlash between the friction plates and the spline teeth of the radially inner splined portion results in a risk of deterioration of ease of assembling of the friction plates with respect to the second rotary member.

However, the spacing interval between the adjacent spline teeth of the radially inner splined portion in the rotating direction decreases in the direction of the axis in which the friction plates are brought into the spline engagement with the radially inner splined portion during assembling of the friction plates with respect to the second rotary member. Accordingly, the friction plates are brought into the spline engagement with the radially inner splined portion during assembling of the friction plates with respect to the second rotary member, in the direction of the axis from one axial end of the radially inner splined portion at which the spacing interval is the largest, toward the other axial end. The largest spacing interval at the above-indicated axial end of the radially inner splined portion provides a gap between the friction plates and the spline teeth at the above-indicated axial end, which gap is large enough to permit easy assembling of the friction plates with respect to the second rotary member.

In the frictional coupling device according to the second mode of the invention, the direction in which the friction discs are axially brought into the spline engagement with the radially outer splined portion during assembling of the friction discs with respect to the first rotary member is the same as a direction in which the frictional coupling portion is pressed by the piston. Accordingly, when the frictional coupling portion is pressed by the piston, the friction discs and the friction plates are moved in the direction of the axis, the amount of circumferential backlash between the spline teeth and each of the friction discs in their rotating direction is reduced as the friction discs are axially moved, so that the sound of collision of the friction discs against the spline teeth generated upon elimination of the circumferential backlash is effectively reduced.

In the frictional coupling device according to the third mode of the invention wherein the cushion spring is disposed on one side of the frictional coupling portion remote from the piston, the friction discs and the friction plates are moved with the biasing force of the cushion spring to positions in which the frictional coupling portion is placed in a released state, when the frictional coupling portion is switched from an engaged state to the released state. Accordingly, it is possible to reduce a risk that the friction discs and the friction plates are kept in positions in which the frictional coupling portion is placed in the engaged state.

In the frictional coupling device according to the fourth mode of the invention, no amount of circumferential backlash in the rotating direction of the radially outer splined portion exists between the spline teeth of the radially outer splined portion and radially inner teeth of one of the friction discs which is located furthest from the piston in the direction of the axis, when the frictional coupling portion is placed in the engaged state. Accordingly, there is no risk of generation of a sound of collision of the friction discs against the spline teeth of the radially outer splined portion upon elimination of the circumferential backlash. Although there is a risk that the friction discs are kept stuck in the engaged state of the frictional coupling portion, even when the frictional coupling portion is switched from the engaged state to the released state. However, the friction discs are forced to be moved with the biasing force of the cushion spring, toward the positions in which the frictional coupling portion is placed in the released state, whereby the risk of sticking of the friction discs to the spline teeth of the radially outer splined portion is reduced.

### BRIEF DESCRIPTION OF THE DRAWINGS

FIG. 1 is a schematic view showing an arrangement of a vehicular power transmitting system provided with a frictional coupling device constructed according to a first embodiment of this invention;

FIG. 2 is a cross sectional view showing an arrangement of a forward/reverse switching device disposed in a power transmitting path between a turbine shaft and a continuously variable transmission, which are shown in FIG. 1;

FIG. 3 is an exploded view of a radially outer splined portion of a carrier hub shown in FIG. 2, which is exploded in a circumferential direction of the radially outer splined portion;

FIG. 4 is a cross sectional view showing an arrangement of a frictional coupling device in the form of a forward drive clutch constructed according to a second embodiment of this invention;

FIG. 5 is an exploded view of a radially outer splined portion of a carrier hub shown in FIG. 4, which is exploded in a circumferential direction of the radially outer splined portion; and

FIG. 6 is an exploded view of a radially inner splined portion formed on a drum of a frictional coupling device in the form of a forward drive clutch constructed according to a third embodiment of the invention.

### DETAILED DESCRIPTION OF PREFERRED EMBODIMENTS

Preferred embodiments of the present invention will be described in detail by reference to the drawings. It is to be understood that the drawings showing the embodiments are simplified or transformed as needed, and do not necessarily accurately represent dimensions and shapes of various elements of the embodiment.

### First Embodiment

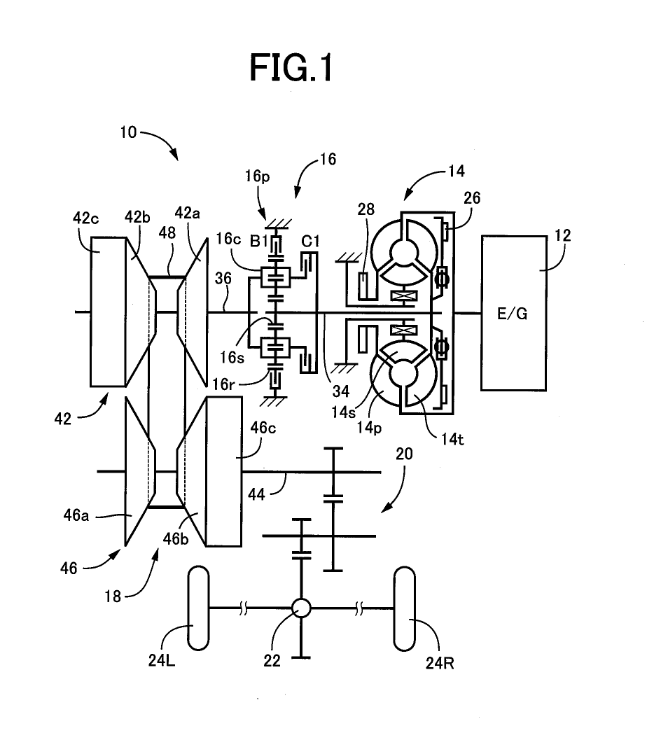

Reference is first made to FIG. 1, which is the schematic view showing an arrangement of a vehicular power transmitting system 10 provided with a frictional coupling device in the form of a forward drive clutch C1 constructed according to a first embodiment of this invention. This vehicular power transmitting system 10 is an automatic transmission of a transversely mounted type which is suitably applicable to an FF type (front-engine front-drive type) vehicle. The vehicular power transmitting system 10 is disposed in a power transmitting path between a vehicle drive power source in the form of an engine 12 and drive wheels 24L and 24R. An output of the internal combustion engine 12 is transmitted to the right and left drive wheels 24R and 24L of a vehicle through a crankshaft of the engine 12, a fluid-operated power transmitting device in the form of a torque converter 14, a forward/reverse switching device 16, a belt-and-pulley type continuously variable transmission (CVT) 18, a speed reducing gear device 20 and a differential gear device 22.

The torque converter 14 is disposed on the power transmitting path between the engine 12 and the drive wheels 24, and includes: a pump impeller 14p connected to a crankshaft of the engine 12; a turbine impeller 14t connected to the forward/reverse switching device 16 through a turbine shaft 34 serving as an output member of the torque converter 14; and a stator impeller 14s which is interposed between the pump impeller 14p and the turbine impeller 14t and which is connectable to a stationary member through a one-way clutch. The torque convert 14 is configured to transmit a drive force via a working fluid. Between the pump impeller 14p and the turbine impeller 14t, there is disposed a lock-up clutch 26 which has an engaging pressure chamber and a releasing pressure chamber and which is selectively placed in an engaged state and a released state, by controlling hydraulic pressures in the engaging and releasing pressure chambers. When the lock-up clutch 26 is placed in a fully engaged state, for example, the pump impeller 14p and the turbine impeller 14t are rotated as a unit.

Thus, the lock-up clutch 26 is configured to selectively connect and disconnect the pump impeller 14p and the turbine impeller 14t of the torque converter 14 to and from each other. A mechanical oil pump 28 is connected to and operated by the pump impeller 14p, to pressurize a working fluid for shifting the continuously variable transmission 18 and applying a tension to a transmission belt 48 of the continuously variable transmission 18 and placing the lock-up clutch 26 in the engaged or released state, and to supply the pressurized working fluid as a lubricant to various points in the vehicular power transmitting system 10.

The forward/reverse switching device 16 includes, as major components, the above-indicated forward drive clutch C 1, a reverse drive brake B1, and a planetary gear set 16p of a double-pinion type including a sun gear 16s, a carrier 16c and a ring gear 16r. The turbine shaft 34 of the torque converter 14 is integrally fixed to the sun gear 16s, and an input shaft 36 of the continuously variable transmission 18 is integrally connected to the carrier 16c. The carrier 16c and the sun gear 16s are selectively connected to each other through the forward drive clutch C1, and the ring gear 16r is selectively fixed to a housing of the power transmitting system 10, through the reverse drive brake B1. Each of the forward drive clutch C1 and the reverse drive brake B1 is a hydraulically operated frictional coupling device including a hydraulic actuator for frictional coupling action. It is noted that the forward drive clutch C1 is the frictional coupling device according to the present invention.

When the forward drive clutch C1 is placed in an engaged state while the reverse drive brake B1 is placed in a released state, the forward/reverse switching device 16 is rotated as a unit, such that the turbine shaft 34 is directly connected to the input shaft 36, so as to establish a forward drive force transmitting path through which a forward drive force is transmitted to the continuously variable transmission 18. When the reverse drive brake B1 is placed in an engaged state while the forward drive clutch C1 is placed in a released state, the forward/reverse switching device 16 is switched so as to establish a reverse drive force transmitting path through which a reverse drive force is transmitted to the continuously variable transmission 18, while the input shaft 36 is rotated in a direction opposite to a direction of rotation of the turbine shaft 34. When the forward drive clutch C1 and the reverse drive brake B1 are both placed in their released states, the forward/reverse switching device 16 is placed in a neutral state, namely, a non-power-transmitting state.

The continuously variable transmission 18 includes: an input rotary member in the form of a driving pulley (primary pulley) 42 which is mounted on the input shaft 36 and an effective diameter of which is variable; an output rotary member in the form of a driven pulley (secondary pulley) 46 which is mounted on an output shaft 44 and an effective diameter of which is variable; and the above-indicated transmission belt 48 connecting the two variable-diameter pulleys 42 and 46 to each other. Thus, the continuously variable transmission 18 is configured to transmit a drive force between the variable-diameter pulleys 42 and 46, through a friction force between the variable-diameter pulleys 42, 46 and the transmission belt 48.

The driving pulley 42 includes: a stationary rotary member 42a fixed to the input shaft 36; a movable rotary member 42b which is rotated together with the input shaft 36 and which is axially movable relative to the input shaft 36; and a driving side hydraulic actuator 42c configured to generate a thrust force for changing a width of a Vee-groove formed between the stationary and movable rotary members 42a and 42b.

The driven pulley 46 includes: a stationary rotary member 46a fixed to the output shaft 44; a movable rotary member 46b which is rotated together with the output shaft 44 and which is axially movable relative to the output shaft 44; and a driven side hydraulic actuator 46c configured to generate a thrust force for changing a width of a Vee-groove formed between the stationary and movable rotary members 46a and 46b.

The widths of the Vee-grooves of the two pulleys 42 and 46 are changed to change the effective diameters of the pulleys 42 and 46 held in engagement with the transmission belt 48, by a hydraulic control circuit configured to control amounts of flows of a working fluid into and from the driving side hydraulic actuator 42c, so that a speed ratio γ of the continuously variable transmission 18 (rotating speed Nin of the input shaft 36/rotating speed Nout of the output shaft 44) is continuously varied. Meanwhile, a tension of the transmission belt 48 is controlled by a hydraulic control circuit configured to regulate a pressure Pd of the working fluid in the driven side hydraulic actuator 46c such that the transmission belt 48 does not slip.

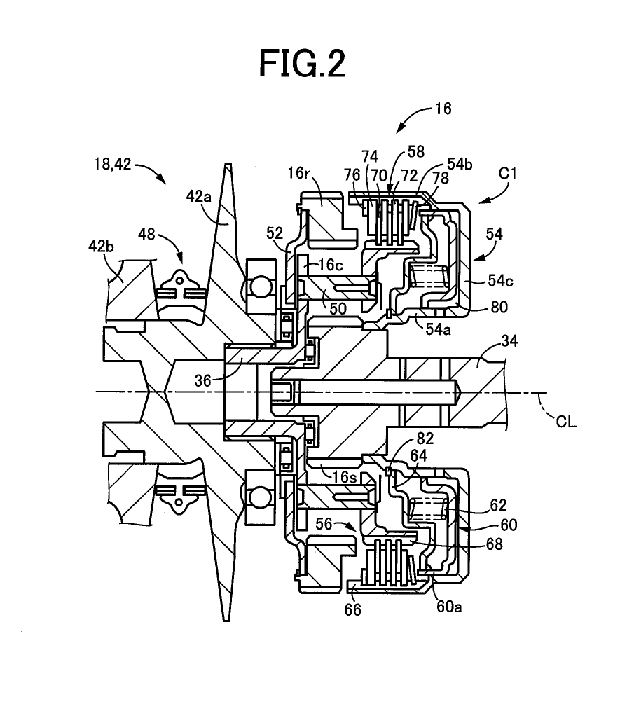

FIG. 2 is the cross sectional view showing a part of the driving pulley 42 shown in FIG. 1, and the forward/reverse switching device 16 disposed in a power transmitting path between the torque converter 14 and the continuously variable transmission 18.

As shown in FIG. 2, the turbine shaft 34, the input shaft 36, and the stationary rotary member 42a of the driving pulley 42 are disposed on an axis CL, in the order of description. Further, the forward/reverse switching device 16 is disposed radially outwardly of the turbine shaft 34. The forward/reverse switching device 16 is disposed on a power transmitting path between the turbine shaft 34 and the driving pulley 42.

FIG. 2 shows the planetary gear set 16p and the forward drive clutch C1 of the forward/reverse switching device 16. It is noted that the reverse drive brake B1 disposed radially outwardly of the planetary gear set 16p is not shown in FIG. 2.

The planetary gear set 16p includes: a sun gear 16s formed integrally with a radially outer portion of the turbine shaft 34; a carrier 16c supporting a carrier pin 50 such that the carrier pin 50 is rotatable about the axis CL; and an annular ring gear 16r having teeth formed in an inner circumferential surface of the ring gear 16r and held in meshing engagement with pinion gears of the planetary gear set 16p (not shown in FIG. 2).

The carrier 16c supports the carrier pin 50 at opposite axial ends of the carrier pin 50. An axial end portion of the carrier 16c on the side of the turbine shaft 34 (on the side of the engine 12: on a right-hand side as seen in the plane of the cross sectional view of FIG. 2) in the direction of the axis CL extends radially outwardly, and is connected at the radially outer end of the carrier 16c to a carrier hub 56 (described below). On the other hand, the other axial end portion of the carrier 16c on the side of the driving pulley 42 (on the side of the continuously variable transmission 18: on a left-hand side as seen in the plane of the cross sectional view of FIG. 2) in the direction of the axis CL extends radially inwardly, and is connected at the radially inner end of the carrier 16c to the input shaft 36.

The ring gear 16r, which is an annular member, is supported by a disc member 52 connected to an axial end face of the disc member 52 on the side of the driving pulley 42 in the direction of the axis CL, such that the ring gear 16r is rotatable about the axis CL. The ring gear 16r has teeth formed in the inner circumferential surface thereof and held in engagement with the pinion gears not shown. The ring gear 16r has spline teeth formed in an outer circumferential surface thereof and serving as a part of the reverse drive brake B1.

Next, the forward drive clutch C1 will be described. The forward drive clutch C1 includes: a drum 54; the above-indicated carrier hub 56; a frictional coupling portion 58 disposed between the drum 54 and the carrier hub 56; a piston 60 configured to press the frictional coupling portion 58; a plurality of springs 62 biasing the piston 60 in the direction of the axis CL away from the frictional coupling portion 58; and a spring holder plate 64 for retaining the springs 62.

The drum 54 is disposed rotatably about the axis CL. The drum 54 is a generally cylindrical member closed at one of opposite axial ends of the drum 54 and having two cylindrical portions. Namely, the drum 54 includes: an inner cylindrical portion 54a; an outer cylindrical portion 54b formed radially outwardly of the inner cylindrical portion 54a; and a disc portion 54c which is formed at the above-indicated one axial end, so as to connect the inner and outer cylindrical portions 54a and 54b. It is noted that the drum 54 functions as a second rotary member of the frictional coupling device according to the present invention.

The inner cylindrical portion 54a is a cylinder connected to the turbine shaft 34, at one of opposite axial end portions of the inner cylindrical portion 54a on the side of the driving pulley 42 in the direction of the axis CL, so that the drum 54 and the turbine shaft 34 are rotated as a unit about the axis CL.

The outer cylindrical portion 54b is a cylinder having a radially inner splined portion 66 formed in an inner circumferential surface of the outer cylindrical portion 54b, so that a plurality of friction plates 72 of the frictional coupling portion 58 are held in spline engagement with the radially inner splined portion 66.

The disc portion 54c is a disc connected at a radially inner end part thereof to an axial end part of the inner cylindrical portion 54a on the side of the turbine shaft 34 in the direction of the axis CL, and is connected at a radially outer end part thereof to an axial end part of the outer cylindrical portion 54b on the side of the turbine shaft 34 in the direction of the axis CL.

The drum 54 has an annular space formed between the inner and outer cylindrical portions 54a and 54b, so that the carrier hub 56, the frictional coupling portion 58, the piston 60, the springs 62 and the spring holder plate 64 are accommodated.

The carrier hub 56 is disposed rotatably about the axis CL. The carrier hub 56 is a cylindrical member disposed radially inwardly of the outer cylindrical portion 54b of the drum 54. The carrier hub 56 is connected to the carrier 16c of the planetary gear set 16p, at an axial end portion of the carrier hub 56 on the side of the driving pulley 42 in the direction of the axis CL. The carrier hub 56 has a radially outer splined portion 68 formed in an outer circumferential surface of the carrier hub 56, so that a plurality of friction discs 70 of the frictional coupling portion 58 are held in spline engagement with the radially outer splined portion 68. It is noted that the carrier hub 56 functions as a first rotary member of the frictional coupling device of the present invention.

The frictional coupling portion 58 is disposed between the carrier hub 56 and the outer cylindrical portion 54b of the drum 54 in a direction perpendicular to the axis, i.e. a radial direction. In the frictional coupling portion 58, the plurality of friction discs 70 held in spline engagement with the radially outer splined portion 68 formed on the outer circumferential surface of the carrier hub 56, and the plurality of friction plates 72 held in spline engagement with the radially inner splined portion 66 formed on the inner circumferential surface of the outer cylindrical portion 54b are alternately disposed in the direction of the axis CL. In the present embodiment, the three friction discs 70 and the three friction plates 72 are alternately disposed adjacent to each other. A flange 74 is splined to the radially inner splined portion 66 of the outer cylindrical portion 54b, and a retainer ring 76 is held in spline engagement with the radially inner splined portion 66, while a cushion spring 78 is disposed adjacent to the piston 60 in the direction of the axis CL.

The plurality of friction discs 70 are annular discs each of which has a plurality of radially inner teeth formed on an inner circumference of the friction disc 70 at a predetermined constant circumferential angular spacing interval. These friction discs 70 are splined at their inner teeth to the radially outer splined portion 68 of the carrier hub 56, so that the friction discs 70 are not substantially rotatable relative to the carrier hub 56, and are movable relative to the carrier hub 56 in the direction of the axis CL. In a strict sense, however, there is formed a certain amount of circumferential backlash between the radially inner teeth of the friction discs 70 and the radially outer splined portion 68 in their circumferential or rotating direction, in view of dimensional variations of the related components, and ease of assembling of the friction discs 70 with respect to the carrier hub 56. Accordingly, the friction discs 70 and the carrier hub 56 (radially outer splined portion 68) are rotatable relative to each other. This circumferential backlash will be described below.

The plurality of friction plates 72 are annular discs each of which has a plurality of radially outer teeth formed on an outer circumference of the friction plate 72 at a predetermined constant circumferential angular spacing interval. These friction plates 72 are splined at radially outer teeth of the friction plates 72 to the radially inner splined portion 66 of the drum 54, so that the friction plates 72 are not substantially rotatable relative to the drum 54, and are movable relative to the drum 54 in the direction of the axis CL. In a strict sense, however, there is formed a certain amount of circumferential backlash between the radially outer teeth of the friction plates 72 and the radially inner splined portion 66 in their circumferential or rotating direction, in view of dimensional variations of the related components, and ease of assembling of the friction plates 72 and the drum 54. Accordingly, the friction plates 72 and the drum 54 (radially inner splined portion 66) are rotatable relative to each other.

The friction discs 70 and the friction plates 72 are alternately disposed adjacent to each other in the direction of the axis CL, and the flange 74 is disposed adjacent to the friction disc 70 nearest to the driving pulley 42 in the direction of the axis CL. This flange 74 is an annular disc having a plurality of radially outer teeth formed on an outer circumference of the flange 74 held in spline engagement with the radially inner splined portion 66.

The retainer ring 76 is disposed on one side of the flange 74 nearer to the driving pulley 42 in the direction of the axis CL. The retainer ring 76 is held in engagement with an annular groove formed in the radially inner splined portion 66 such that the retainer ring 76 is not movable relative to the radially inner splined portion 66 in the direction of the axis CL. Thus, the retainer ring 76 limits a movement of the flange 74 toward the driving pulley 42 in the direction of the axis CL. Described in detail, the movement of the flange 74 toward the driving pulley 42 in the direction of the axis CL is limited by an abutting contact of the flange 74 with the retainer ring 76. Accordingly, movements of the friction discs 70 and the friction plates 72 toward the driving pulley 42 in the direction of the axis CL are limited by the retainer ring 76.

The cushion spring 78 is disposed adjacent to the piston 60 in the direction of the axis CL. The cushion spring 78 is a coned-disc spring splined at a radially outer portion of the spring 78 to the radially inner splined portion 66, so that the cushion spring 78 is rotated together with the drum 54. Since the cushion spring 78 is disposed adjacent to the piston 60 in the direction of the axis CL, the piston 60 is brought into contact with the cushion spring 78 when the piston 60 is moved toward the frictional coupling portion 58 in the direction of the axis CL. As a result, the cushion spring 78 is subjected to elastic deformation, causing generation of an elastic biasing force acting on the piston 60 in an axial direction away from the frictional coupling portion 58. This elastic biasing force prevents an abrupt frictional coupling action of the frictional coupling portion 58.

The piston 60 is accommodated within the drum 54 such that a radially inner portion of the piston 60 is slidable on an outer circumferential surface of the radially inner cylindrical portion 54a while a radially outer portion of the piston 60 is slidable on an inner circumferential surface of the radially outer cylindrical portion 54b, so that the piston 60 and the drum 54 define an oil chamber 80. A flow of the pressurized working fluid into this oil chamber 80 causes the piston 60 to be moved toward the frictional coupling portion 58 in the direction of the axis CL, whereby the piston 60 presses the frictional coupling portion 58. The piston 60 has a pressing portion 60a formed at a radially outer part of the piston 60 so as to extend toward the frictional coupling portion 58 in the direction of the axis CL.

Between the piston 60 and the frictional coupling portion 58 in the direction of the axis CL, there is interposed a spring holder plate 64, which is a disc-like member that is bent in the form of steps as seen in the cross sectional view of FIG. 2. The spring holder plate 64 is held at a radially inner portion of the spring holder plate 64, in abutting contact with a retainer ring 82 fixedly fitted in the outer circumferential surface of the radially inner cylindrical portion 54a of the drum 54, so that a movement of the spring holder plate 64 toward the driving pulley 42 in the direction of the axis CL is limited by the retainer ring 82. The spring holder plate 64 is held at an outer circumferential surface thereof, in an inner circumferential surface of the pressing portion 60a of the piston 60.

Between the piston 60 and the spring holder plate 64 in the direction of the axis CL, there is interposed a plurality of springs 62 such that the springs 62 are spaced apart from each other at a predetermined constant angular spacing interval in a circumferential direction of the piston 60 (spring holder plate 64). These springs 62 apply a biasing force to the piston 60 in the direction of the axis CL away from the frictional coupling portion 58 when the working fluid is not supplied, so that the piston 60 is kept in a fully retracted position thereof remote from the frictional coupling portion 58, in the direction of the axis CL.

In the forward drive clutch C1 constructed as described above, the piston 60 is moved against the biasing force of the springs 62 toward the frictional coupling portion 58 in the direction of the axis CL, with a hydraulic pressure of the pressurized working fluid supplied to the oil chamber 80, so that the piston 60 presses the frictional coupling portion 58. In the presence of the retainer ring 76 fixedly disposed at one axial end of the frictional coupling portion 58 in the direction of the axis CL, distances of the movements of the flange 74, the friction discs 70 and the friction plates 72 in the direction of the axis CL are limited, so that the flange 74, friction discs 70 and friction plates 72 frictionally contact each other, generating mutual frictional engaging forces acting against each other. Thus, the forward drive clutch C1 is placed in an engaged state in which the drum 54 and the carrier hub 56 are rotated as a unit.

By the way, it is known that the engine 12 suffers from variations of an operating speed and output torque of the engine 12 during a cycling operation of the engine 12 including the combustion and explosion stroke. These variations of the operating speed and output torque of the engine 12 are transmitted to the forward/reverse switching device 16 and the continuously variable transmission 18. Although the variations of the operating speed and output torque are absorbed by the torque converter 14 during running of the vehicle at comparatively low speed and drive torque, those variations are transmitted to the forward/reverse switching device 16 and the continuously variable transmission 18 through the lock-up clutch 26, which is placed in the engaged state when a running speed of the vehicle become higher than certain upper limits. While a damper device is interposed between the lock-up clutch 26 and the turbine shaft 34, the variations of the operating speed and output torque of the engine 12 that cannot be absorbed by the damper device are transmitted to the forward/reverse switching device 16.

The forward drive clutch C1 is further configured such that some amounts of circumferential backlash are formed or left between the radially outer splined portion 68 of the carrier hub 56 and the friction discs 70, and between the radially inner splined portion 66 of the drum 54 and the friction plates 72, in their circumferential direction, in view of their dimensional variations and ease of assembling of the friction discs and plates 70, 72 with respect to the carrier hub 56 and the drum 54. In this respect, it is noted that a drive torque transmitted to the forward/reverse switching device 16 and the continuously variable transmission 18 changes between positive and negative values during running of the vehicle with a comparatively small output torque of the engine 12. The variations of the operating speed and output torque of the engine 12 transmitted to the forward drive clutch C1 in the above-indicated running state of the vehicle give rise to a risk of elimination (or reduction of the amounts) of the above-indicated circumferential backlash, and consequent successive collisions of the related components against each other, and generation of a butting sound by those components. Although it is considered possible to design the torque converter 14 such that the torque converter 14 absorbs the operating speed and output torque of the engine 12 with the lock-up clutch 26 released, this solution to solve the above-indicated problem results in reducing a range of operation in which the lock-up clutch 26 is placed in the engaged state, causing another problem that fuel economy of the engine 12 is deteriorated.

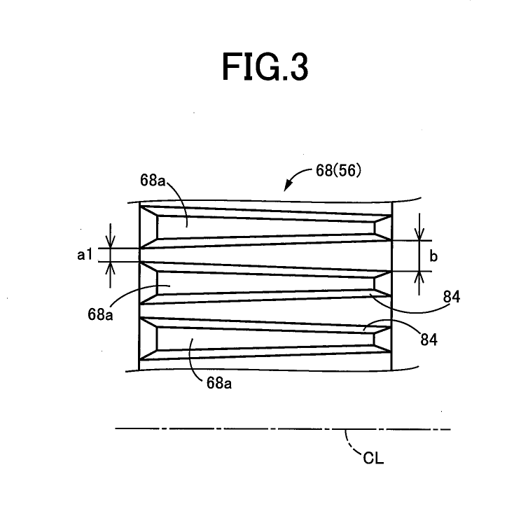

To solve the problem described above, the present embodiment is configured such that the radially outer splined portion 68 to which the friction discs 70 are splined has a plurality of spline teeth 68a which are spaced apart from each other in the circumferential direction of the radially outer splined portion 68 at a predetermined constant circumferential angular spacing interval. The spline teeth 68a are formed such that a spacing distance between the adjacent spline teeth 68a in the circumferential or rotating direction of the radially outer splined portion 68 decreases in the direction of the axis CL from the turbine shaft 34 toward the driving pulley 42. FIG. 3 is the exploded view showing a part of circumference of the radially outer splined portion 68 of the carrier hub 56, which view is exploded in the circumferential direction of the radially outer splined portion 68. It is noted that the right-hand and left-hand sides as seen in the plane of FIG. 3 respectively correspond to the sides of the turbine shaft 34 and the driving pulley 42 in the direction of the axis CL.

As shown in FIG. 3, the spline teeth 68a extend in the direction of the axis CL, and the spacing distance between the adjacent spline teeth 68a in the circumferential or rotating direction of the radially outer splined portion 68 changes along the direction of the axis CL. Described more specifically, the adjacent spline teeth 68a have a spacing distance b at one of the opposite axial ends of the radially outer splined portion 68, which is on the side of the turbine shaft 34, namely, at the right-hand side axial end as seen in the plane of FIG. 3, and a spacing distance a1 at the other axial end (left-hand side axial end) of the radially outer splined portion 68 on the side of the driving pulley 42. The spacing distance b is longer than the spacing distance a1, that is, b1>a1. The spacing distance between the adjacent spline teeth 68a decreases in the direction of the axis CL from the turbine shaft 34 toward the driving pulley 42.

As also shown in FIG. 3, the adjacent spline teeth 68a have respective tapered surfaces 84 which are formed such that a spacing distance between these tapered surfaces 84 in the rotating or circumferential direction of the radially outer splined portion 68 continuously decreases in the direction of the axis CL from the turbine shaft 34 toward the driving pulley 42.

The spacing distance a1 between the adjacent spline teeth 68a in the rotating direction of the radially outer splined portion 68 and at the axial end on the side of the driving pulley 42 in the direction of the axis CL is determined such that an amount of circumferential backlash between the spline teeth 68a and the radially inner teeth of the friction disc 70 located nearest to the driving pulley 42 in the direction of the axis CL is a sufficiently small value larger than zero, when the forward drive clutch C1 is placed in the engaged state. In this respect, it is noted that the spacing distance a1 between the spline teeth 68a adjacent to each other in the rotating direction of the radially outer splined portion 68 is determined to be smaller than a spacing distance between the adjacent spline teeth in the conventional frictional coupling device, which spacing distance is constant over an entire length of the radially outer splined portion in the direction of the axis CL. The amount of circumferential backlash between the spline teeth 68a and the radially inner teeth of the friction disc 70 located nearest to the driving pulley 42 in the direction of the axis CL is determined to be larger than zero in the engaged state of the forward drive clutch C1, in order to prevent the forward drive clutch C1 from being kept in the engaged state, with the friction discs 70 being kept stuck to the radially outer splined portion 68 when the forward drive clutch C1 is switched from the engaged state to the released state.

Upon assembling of the friction discs 70 with respect to the radially outer splined portion 68, the friction discs 70 are brought into spline engagement with the spline teeth 68a in the direction of the axis CL from the axial end of the radially outer splined portion 68 at which the spacing distance is the largest value of “b”, toward the other axial end of the radially outer splined portion 68 at which the spacing distance is the smallest value “a1”. In other words, the friction discs 70 are brought into spline engagement with the spline teeth 68a in the direction of the axis CL from the turbine shaft 34 toward the driving pulley 42, that is, in the direction in which the spacing interval between the adjacent spline teeth 68a in the rotating direction of the radially outer splined portion 68 decreases. Thus, the assembling of the friction discs 70 with respect to the radially outer splined portion 68 is facilitated owing to a continuous decrease of the spacing distance from the largest value “b” to the smallest value “a1” in the direction of movement of the friction discs 70 relative to the radially outer splined portion 68 during assembling of the friction discs 70 with respect to the radially outer splined portion 68.

Upon assembling of the forward drive clutch C1, the piston 60 is initially fitted into the drum 54, and the springs 62 and the spring holder plate 64 are then accommodated in the drum 54 in this order of description. Then, the cushion spring 78 and the friction plates 72 are brought into spline engagement with the radially inner splined portion 66 of the drum 54, such that the friction discs 70 and the friction plates 72 are alternately disposed adjacent to each other. Successively, the flange 74 and the retainer ring 76 are brought into spline engagement with the radially inner splined portion 66. Then, the radially inner teeth of the friction discs 70 are brought into spline engagement with the radially outer splined portion 68 of the carrier hub 56. At this time, the friction discs 70 are moved relatively toward the radially outer splined portion 68 in the direction of the axis CL, namely, in the direction of the axis CL from the turbine shaft 34 toward the driving pulley 42 as seen FIG. 2, that is, in the direction in which the spacing distance between the adjacent spline teeth 68a decreases, and in which the friction discs 70 are moved relative to the radially outer splined portion 68 upon assembling of the friction discs 70 with respect to the radially outer splined portion 68.

It is further noted that the spacing distance between the adjacent spline teeth 68a of the radially outer splined portion 68 in the rotating direction decreases in the direction of the axis CL in which the frictional coupling portion 58 is pressed by the piston 60. Namely, the direction in which the friction discs 70 are axially brought into spline engagement with the radially outer splined portion 68 during assembling of the friction discs 70 with respect to the carrier hub 56 is the same as the direction in which the friction discs 70 are pressed by the piston 60. Therefore, the amount of circumferential backlash between the spline teeth 68a of the radially outer splined portion 68 and the radially inner teeth of the friction disc 70 nearest to the driving pulley 42 in the direction of the axis CL is minimized when the friction discs 70 and the friction plates 72 have been brought into engagement with each other as a result of movement of the frictional coupling portion 58 by a pressing action of the piston 60 in the direction of the axis CL.

In the present embodiment, the three friction discs 70 are held in spline engagement with the spline teeth 68a of the radially outer splined portion 68. Since these three friction discs 70 have the same dimensions, the amounts of circumferential backlash between the spline teeth 68a and the radially inner teeth of the three friction discs 70 in the rotating direction of the radially outer splined portion 68 after assembling of the three friction discs 70 with respect to the splined portion 68 decrease in the order of positions of installation of the three friction discs 70 as seen in the direction of the axis CL from the turbine shaft 34 toward the driving pulley 42. When an operator of the vehicle operates a shift lever from a neutral position N for placing the power transmitting system 10 in a power non-transmitting state to a forward drive position D for placing the power transmitting system 10 in a forward drive state, for instance, the friction discs 70 are rotated in a forward drive direction, initially in a partially engaged or slipping state of the forward drive clutch C1, and eventually in a fully engaged state of the forward drive clutch C1, as a result of the pressing action of the piston 60 with respect to the frictional coupling portion 58. At this time, the different amounts of circumferential backlash between the spline teeth 68a and the three friction discs 70 exist in one of opposite rotating directions about the axis CL, which one rotating direction corresponds to a reverse vehicle driving direction. However, the amounts of circumferential backlash are zeroed in the other rotating direction corresponding forward vehicle driving direction, for all of the three friction discs 70. Accordingly, the vehicle drive force is stably transmitted from the drum 54 to the carrier hub 56.

Where the direction of transmission of the vehicle drive torque to the forward drive clutch C1 is reversed or changed (for example, from the forward vehicle driving direction to a non-vehicle-driving direction) due to variations of the operating speed and output torque of the engine 12 during forward running of the vehicle, the amounts of circumferential backlash between the spline teeth 68a and the friction discs 70 are zeroed in the rotating direction corresponding to the newly established direction of transmission of the vehicle drive torque. At this time, the spline teeth 68a and the friction discs 70 are rotated relative to each other. An amount of this relative rotation corresponds to the amount of circumferential backlash existing between the spline teeth 68a and the friction disc 70 located nearest to the driving pulley 42 in the direction of the axis CL. Accordingly, a sound of collision (butting sound) generated upon elimination of the circumferential backlash is reduced. In this respect, the spacing distance a1 is determined by experimentation or theoretical analysis such that the sound of collision to be generated upon elimination of the circumferential backlash between the spline teeth 68a and the friction discs 70 cannot be perceived by the vehicle operator.

It is noted here that the ease of assembling of the friction discs 70 with respect to the carrier hub 56, namely, the ease of spline engagement of the friction discs 70 with the radially outer splined portion 68 is lowered as the amounts of circumferential backlash between the friction discs 70 and the spline teeth 68a are reduced. However, there exists the relatively long spacing distance b between the adjacent spline teeth 68a, at the axial end of the radially outer splined portion 68 from which the friction discs 70 are moved toward the driving pulley 42, for spline engagement with the spline teeth 68a. Accordingly, the friction discs 70 can be easily assembled with respect to the radially outer splined portion 68 of the carrier hub 56. That is, the risk of deterioration of the ease of assembling of the friction discs 70 is effectively reduced.

As described above, the present first embodiment is configured such that the spacing distance between the adjacent spline teeth 68a of the radially outer splined portion 68 in the rotating direction decreases in the direction of the axis CL in which the friction discs 70 are brought into the spline engagement with the radially outer splined portion 68 during assembling of the friction discs 70 with respect to the carrier hub 56. Accordingly, the amount of circumferential backlash in the rotating direction of the carrier hub 56 existing between the spline teeth 68a of the radially outer splined portion 68 and the first friction disc 70 which is first brought into the spline engagement with the radially outer splined portion 68 in the direction of the axis CL is small enough to reduce the sound of collision of the friction discs 70 against the spline teeth 68a, which is generated upon elimination of the circumferential backlash between the friction discs 70 and the spline teeth 68a in the rotating direction of the carrier hub 56 when the direction of transmission of the vehicle drive torque to the forward drive clutch C1 is reversed in the engaged state of the frictional coupling portion 58, as compared to a case where the amount of the backlash is constant irrespective of the axial position. On the other hand, reduction of the circumferential backlash between the friction discs 70 and the spline teeth 68a of the radially outer splined portion 68 results in the risk of deterioration of the ease of assembling of the friction discs 70 with respect to the carrier hub 56. However, the spacing interval between the adjacent spline teeth 68a of the radially outer splined portion 68 in the rotating direction decreases in the direction of the axis CL in which the friction discs 70 are brought into the spline engagement with the radially outer splined portion 68 during assembling of the friction discs 70 with respect to the carrier hub 56. Accordingly, the friction discs 70 are brought into the spline engagement with the radially outer splined portion 56 during assembling of the friction discs 70 with respect to the carrier hub 56, in the direction of the axis CL from one axial end of the radially outer splined portion 68 at which the spacing interval is the largest, toward the other axial end. The largest spacing interval at the above-indicated axial end of the radially outer splined portion 68 provides a gap between the friction discs 70 and the spline teeth 68a at the above-indicated axial end, which is large enough to permit easy assembling of the friction discs 70 with respect to the carrier hub 56.

The present embodiment is further configured such that the direction in which the friction discs 70 are axially brought into the spline engagement with the radially outer splined portion 68 during assembling of the friction discs 70 with respect to the carrier hub 56 is the same as the direction in which the frictional coupling portion 58 is pressed by the piston 60. Accordingly, when the frictional coupling portion 58 is pressed by the piston 60, the friction discs 70 and the friction plates 72 are moved in the direction of the axis CL, the amount of circumferential backlash between the spline teeth 68a and each of the friction discs 70 in their rotating direction is reduced as the friction discs 70 are axially moved, so that the sound of collision of the friction discs 70 against the spline teeth 68a generated upon elimination of the circumferential backlash is effectively reduced.

Other embodiments of this invention will be described. It is to be understood that the same reference signs as used in the first embodiment will be used to identify the corresponding elements in the following embodiments, which will not be described redundantly.

### Second Embodiment

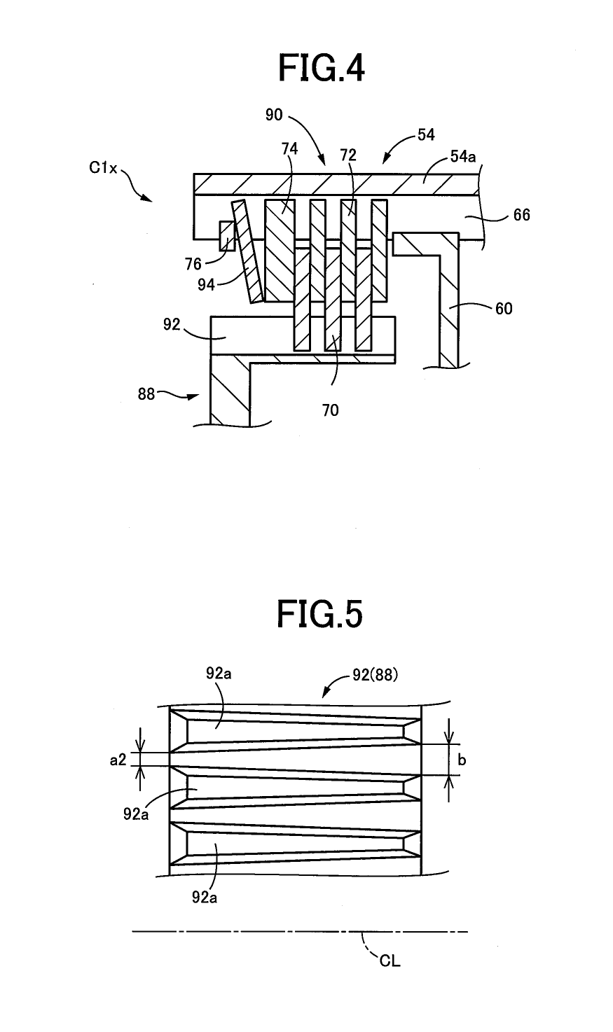

FIG. 4 is the cross sectional view showing an arrangement of a frictional coupling device in the form of a forward drive clutch C1x constructed according to a second embodiment of this invention. The forward drive clutch C1x includes the drum 54, a carrier hub 88, a frictional coupling portion 90 disposed between the drum 54 and the carrier hub 88, and the piston 60 for pressing the frictional coupling portion 90. The drum 54 and the piston 60 which have been described with respect to the first embodiment will not be further described. The forward drive clutch C1x further includes the springs 62, the spring retainer plate 64, etc. which are not shown in FIG. 4. It is noted that the forward drive clutch C1x functions as the frictional coupling device according to the present invention, while the carrier hub 88 functions as the first rotary member of the frictional coupling device.

The frictional coupling portion 90 includes the three friction discs 70 splined to a radially outer splined portion 92 of the carrier hub 88, and the three friction plates 72 splined to the radially inner splined portion 66 of the radially outer cylindrical portion 54b of the drum 54. These three friction discs 70 and the three friction plates 72 are alternately disposed adjacent to each other in the direction of the axis CL. Further, the flange 74 is splined to the radially inner splined portion 66, and the retainer ring 76 is held in spline engagement with the radially inner splined portion 66, while a cushion spring 94 is interposed between the flange 74 and the retainer ring 76 in the direction of the axis CL. It is noted that the same reference signs as used in the first embodiment are used in the second embodiment, to identify the friction discs 70, friction plates 72, flange 74 and retainer ring 76, which will not be further described.

In the present second embodiment, the cushion spring 94 is disposed adjacent to the flange 74 in the direction of the axis CL, and on one side of the frictional coupling portion 90 remote from the piston 60 in the direction of the axis CL. The cushion spring 94 generates a biasing force acting on the frictional coupling portion 90 in the direction of the axis CL toward the piston 60. In the present embodiment wherein the cushion spring 94 is interposed between the flange 74 and the retainer ring 76 in the direction of the axis CL, the biasing force of the cushion spring 94 is applied to the frictional coupling portion 90 through the flange 74 when the forward drive clutch C1x is switched from an engages state to a released state, so that the friction discs 70 and the friction plates 70 are moved with the biasing force of the cushion spring 94 in the direction of the axis CL, to positions in which the forward drive clutch C1x is placed in the released state, whereby the flange 74, friction discs 70 and friction plates 72 are prevented from being kept at positions in which the forward drive clutch C1x is placed in the engaged state.

FIG. 5 is the exploded view of the radially outer splined portion 92 of the carrier hub 88, which is exploded in a circumferential direction of the radially outer splined portion 92. FIG. 5 corresponds to FIG. 3 showing the first embodiment. It is noted that the right-hand and left-hand sides as seen in the plane of FIG. 5 respectively correspond to the sides of the turbine shaft 34 and the driving pulley 42 in the direction of the axis CL. In the present second embodiment, too, a spacing distance between adjacent spline teeth 92a of the radially outer splined portion 92 in the circumferential or rotating direction of the radially outer splined portion 92 changes in the direction of the axis CL. Described more specifically, the adjacent spline teeth 92a have a spacing distance b at one of the opposite axial ends of the radially outer splined portion 92, which is on the side of the turbine shaft 34, and a spacing distance a2 at the other axial end of the radially outer splined portion 92 on the side of the driving pulley 42. The spacing distance b is longer than the spacing distance a2, that is, b>a2.

The spacing distance between the adjacent spline teeth 92a decreases in the direction of the axis CL from the turbine shaft 34 toward the driving pulley 42. Also in this embodiment, the friction discs 70 are brought into spline engagement with the spline teeth 92a in the direction of the axis CL from the turbine shaft 34 toward the driving pulley 42, that is, in the direction in which the spacing interval between the adjacent spline teeth 92a in the rotating direction of the radially outer splined portion 92 decreases. Thus, the assembling of the friction discs 70 with respect to the radially outer splined portion 92 is facilitated owing to a continuous decrease of the spacing distance from the largest value “b” to the smallest value “a2” in the direction of movement of the friction discs 70 relative to the radially outer splined portion 92 during assembling of the friction discs 70 with respect to the radially outer splined portion 92.

The spacing distance a2 between the adjacent spline teeth 92a in the rotating direction of the radially outer splined portion 92 and at an axial end on the side of the driving pulley 42 in the direction of the axis

CL is determined such that an amount of circumferential backlash between the spline teeth 92a and radially inner teeth of the friction disc 70 located nearest to the driving pulley 42, that is, furthest from the piston 60 in the direction of the axis CL is zero or substantially zero, when the forward drive clutch C1x (frictional coupling portion 90) is placed in the engaged state. By thus determining the spacing distance a2 such that the amount of circumferential backlash between the spline teeth 92a and the friction disc 70 located nearest to the driving pulley 42 in the direction of the axis CL is zero, a sound of collision of the friction discs 70 and the spline teeth 92a against each other due to their relative rotation will not be generated even when the direction of transmission of the vehicle drive torque through the forward drive clutch C1x is reversed in the engaged state of the forward drive clutch C1x.

As described above, the sound of collision will not be generated in the engaged state of the forward drive clutch C1x since the amount of circumferential backlash between the spline teeth 92a and the radially inner teeth of the friction disc 70 located nearest to the driving pulley 42 in the direction of the axis CL is determined to be zero. However, there is a risk that the friction discs 70 are kept stuck to the radially outer splined portion 92 in the engaged state of the forward drive clutch C1x, even when the piston 60 is moved away from the frictional coupling portion 90 as a result of a releasing action of the forward drive clutch C1x. That is, the forward drive clutch C1x may not be normally brought into the released state.

In view of the risk described above, the present second embodiment is configured such that the cushion spring 94 is interposed between the retainer ring 76 and the flange 74 in the direction of the axis CL, so that when the piston 60 is moved apart from the frictional coupling portion 90, the friction discs 70 are forced to be moved with the biasing force of the cushion spring 94 to the position in which the forward drive clutch C1x is placed in the released state. Accordingly, the friction discs 70 are not kept stuck to the radially outer splined portion 92 in the engaged state of the forward drive clutch C1x, and the forward drive clutch C1x is stably brought into the released state. Thus, the forward drive clutch C1x is surely prevented from being kept in the engaged state when the power transmitting system 10 is placed in a position other than the forward drive position, whereby the frictional coupling portion 90 is prevented from suffering from seizure due to continued frictional contact with the friction plates 72.

As described above, the present second embodiment has substantially the same advantages as the first embodiment. Further, the present embodiment is configured such that the cushion spring 94 is interposed between the retainer ring 76 and the flange 74 in the direction of the axis CL, so that when the forward drive clutch C1x is brought into the released state, the friction discs 70 are forced to be moved with the biasing force of the cushion spring 94 to the position in which the forward drive clutch C1x is placed in the released state. Therefore, the friction discs 70 are prevented from being kept stuck to the radially outer splined portion 92. Accordingly, the amount of circumferential backlash existing in the engaged state of the forward drive clutch C1x between the spline teeth 92a of the radially outer portion 92 and the radially inner teeth of the friction disc 70 located nearest to the driving pulley 42 in the direction of the axis CL can be set to be zero, whereby it is possible further to reduce the sound of collision (butting) of the friction discs 70 against the spline teeth 92a, which is generated when the direction of transmission of the vehicle drive torque to the forward drive clutch C1x is reversed.

### Third Embodiment

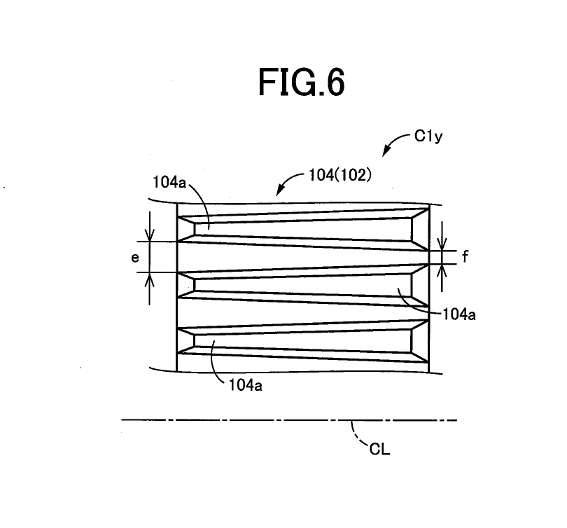

FIG. 6 is the exploded view of a radially inner splined portion 104 formed on a drum 102 of a frictional coupling device in the form of a forward drive clutch C1y constructed according to a third embodiment of the invention. It is noted that the right-hand and left-hand sides as seen in the plane of FIG. 6 respectively correspond to the sides of the turbine shaft 34 and the driving pulley 42 in the direction of the axis CL.

The present third embodiment is configured such that a spacing distance between spline teeth 104a of the radially inner splined portion 104 in the rotating or circumferential direction of the splined portion 104 changes in a direction of the axis CL. Described more specifically, the adjacent spline teeth 104a have a spacing distance e at one of the opposite axial ends of the radially inner splined portion 104, which is on the side of the driving pulley 42, and a spacing distance f at the other axial end of the radially outer splined portion 92 on the side of the turbine shaft 34. As shown in FIG. 6, the spacing distance e is longer than the spacing distance f, that is, e>f. The spacing distance between the adjacent spline teeth 104a decreases in the direction of the axis CL from the driving pulley 42 toward the turbine shaft 34, namely, from an open axial end of the drum 102 toward a closed axial end of the drum 102. It is further noted that upon assembly of the friction plates 72 with respect to the drum 102, the friction plates 72 are brought into spline engagement with the radially inner splined portion 104 in the direction of the axis CL from the driving pulley 42 toward the turbine shaft 34. Accordingly, the spacing distance between the adjacent spline teeth 104a in the rotating direction of the radially inner splined portion 104 decreases in the direction of the axis CL in which the friction plates 72 are brought into the spline engagement with the radially inner splined portion 104. It is also noted that the drum 102 functions as the second rotary member of the frictional coupling device according to the present invention in the form of the forward drive clutch C1y.

The spacing distance e between the adjacent spline teeth 104a in the rotating direction of the radially inner splined portion 104 is determined so that the friction plates 72 can be easily brought into the spline engagement with the spline teeth 104a, upon assembling of the friction plates 72 with respect to the drum 102. On the other hand, the spacing distance f between the adjacent spline teeth 104a is determined such that an amount of circumferential backlash between the spline teeth 104a and the radially outer teeth of the friction plate 72 located nearest to the turbine shaft 34 in the direction of the axis CL is a sufficiently small value larger than zero, when the forward drive clutch C1y is placed in an engaged state, where the cushion spring 78 is disposed adjacent to the piston 60 as in the first embodiment of FIG. 2. In this respect, it is noted that the spacing distance f between the adjacent spline teeth 104a is determined to be smaller than a spacing distance between the adjacent spline teeth in the conventional frictional coupling device, which spacing distance is constant over an entire length of the radially inner splined portion in the direction of the axis CL. Further, the spacing distance f is determined such that the sound of collision to be generated upon elimination of the circumferential backlash between the spline teeth 104a and the friction plates 72 cannot be perceived by the vehicle operator. Where the cushion spring 94 is disposed on one side of the flange 74 remote from the piston 60 as in the second embodiment of FIG. 4, the spacing distance f is preferably determined such that the amount of circumferential backlash between the spline teeth 104a of the radially inner splined portion 104 and the radially outer teeth of the friction plate 72 located nearest to the turbine shaft 34 in the direction of the axis CL is zero in the engaged state of the forward drive clutch C1y.

As described above, the distance between the adjacent spline teeth 104a of the radially inner splined portion 104 of the drum 102 in the rotating direction decreases in the direction of the axis CL from the driving pulley 42 toward the turbine shaft 34, so that the smallest amount of circumferential backlash exists between the spline teeth 104a and the radially outer teeth of the friction plate 72 located nearest to the turbine shaft 34 in the direction of the axis CL. Accordingly, the present third embodiment has substantially the same advantages as the first and second embodiments. Where the direction of transmission of the vehicle drive torque to the forward drive clutch C1y is reversed during forward running of the vehicle, for example, the amounts of circumferential backlash between the spline teeth 104a and the friction plates 72 are zeroed in the rotating direction corresponding to the newly established direction of transmission of the vehicle drive torque. At this time, the spline teeth 104a and the friction plates 72 are rotated relative to each other. An amount of this relative rotation corresponds to the amount of circumferential backlash existing between the spline teeth 104a and the friction plates 72 located nearest to the turbine shaft 34 in the direction of the axis CL. Accordingly, a sound of collision (butting sound) generated upon elimination of the circumferential backlash is reduced.

It is noted that the ease of assembling of the friction plates 72 with respect to the drum 102, namely, the ease of spline engagement of the friction plates 72 with the radially inner splined portion 104 is lowered as the amount of circumferential backlash between the friction plates 72 and the spline teeth 104a are reduced. However, there exists the relatively long spacing distance e between the adjacent spline teeth 104a, at the axial end of the radially inner splined portion 104 from which the friction plates 72 are moved toward the turbine shaft 34, for easy spline engagement with the spline teeth 104a. Accordingly, the friction plates 72 can be easily assembled with respect to the radially inner splined portion 104 of the drum 102. That is, the risk of deterioration of the ease of assembling of the friction plates 72 is effectively reduced.

As described above, the third embodiment is configured such that the spacing distance between the adjacent spline teeth 104a of the radially inner splined portion 104 in the rotating direction decreases in the direction of the axis CL in which the friction plates 72 are brought into the spline engagement with the radially inner splined portion 104 during assembling of the friction plates 72 with respect to the drum 102. Accordingly, the amount of circumferential backlash in the rotating direction of the drum 102 existing between the spline teeth 104a of the radially inner splined portion 104 and the first friction plate 72, which is first brought into the spline engagement with the radially inner splined portion 104 in the direction of the axis CL is small enough to reduce the sound of collision of the friction plates 72 against the spline teeth 104a, which is generated upon elimination of the circumferential backlash between the friction plates 72 and the spline teeth 104a in the rotating direction of the drum 102 when the direction of transmission of the vehicle drive torque to the forward drive clutch C1y is reversed in the engaged state of the forward drive clutch C1y, as compared to a case where the amount of the backlash is constant irrespective of the axial position. On the other hand, reduction of the circumferential backlash between the friction plates 72 and the spline teeth 104a of the radially inner splined portion 104 results in a risk of deterioration of ease of assembling of the friction plates 72 with respect to the drum 102. However, the spacing interval between the adjacent spline teeth 104a of the radially inner splined portion 104 in the rotating direction decreases in the direction of the axis CL in which the friction plates 72 are brought into the spline engagement with the radially inner splined portion 104 during assembling of the friction plates 72 with respect to the drum 102. Accordingly, the friction plates 72 are brought into the spline engagement with the radially inner splined portion 104 during assembling of the friction plates 72 with respect to the drum 102 in the direction of the axis CL from one axial end of the radially inner splined portion 104 at which the spacing interval is the largest, toward the other axial end. The largest spacing interval e at the above-indicated axial end of the radially inner splined portion 104 provides a gap between the friction plates 72 and the spline teeth 104a at the above-indicated axial end, which gap is large enough to permit easy assembling of the friction plates 72 with respect to the drum 102.

While the preferred embodiments of the invention have been described in detail by reference to the drawings, the invention may be otherwise embodied.

For example, the principle of the present invention may incorporate the features of the illustrated first and third embodiments, or the features of the illustrated second and third embodiments. Namely, the frictional coupling device according to the invention may be configured such that the distance between the spline teeth of the radially outer splined portion of the carrier hub in the rotating direction decreases in the axial direction in which the friction discs are brought into spline engagement with the spline teeth of the radially outer splined portion, while at the same time the distance between the spline teeth of the radially inner splined portion of the drum in the rotating direction decreases in the axial direction in which the friction plates are brought into spline engagement with the spine teeth of the radially inner splined portion. In this case, not only the sound of collision of the friction discs against the radially outer splined portion, but also the sound of collision of the friction plates against the radially inner splined portion can be effectively reduced.

The frictional coupling devices according to the illustrated embodiments are the forward drive clutches C1, C1x and C1y provided in the forward/reverse switching device 16, which are configured such that the distance between the spline teeth 68a, 92a of the radially outer splined portion 68, 92 in the rotating direction, or the distance between the spline teeth 104a of the radially inner splined portion 104 in the rotating direction decreases in the direction of the axis CL toward the driving pulley 42 or the turbine shaft 34. However, the frictional coupling device of the present invention may be other than those forward drive clutches C1, C1x and C1y. For instance, the present invention is applicable to the lock-up clutch 26 incorporated in the torque converter 14, where the lock-up clutch 26 is provided with a plurality of friction discs and a plurality of friction plates. Further, the invention is applicable to the reverse drive brake B1 incorporated in the forward/reverse switching device 16. Although the forward drive clutches C1, C1x and C1y according to the illustrated embodiments are provided together with the belt-and-pulley type continuously variable transmission 18, the frictional coupling device of the invention may be provided together with a step-variable automatic transmission, for example. In essence, the frictional coupling device of the invention is provided in a vehicular power transmitting system.

In the illustrated second embodiment of FIG. 4 wherein the cushion spring 94 is disposed on one side of the flange 74 remote from the piston 60 as shown in FIG. 4, the amount of circumferential backlash between the spline teeth 92a of the radially outer splined portion 92 and the radially inner spline teeth of the friction disc 70 located nearest to the driving pulley 42 in the direction of the axis CL is determined to be zero.

However, the amount of circumferential backlash need not be determined to be zero, but may be determined to be larger than zero.

In the illustrated embodiments, the frictional coupling portion 58, 90 includes the three friction discs 70 and the three friction plates 72. However, the numbers of the friction discs and friction plates may be suitably determined.

In the illustrated first embodiment, the forward drive clutch C1 is provided with the cushion spring 78 for preventing an abrupt engaging action of the frictional coupling portion 58. However, the frictional coupling device of the present invention need not be provided with the cushion spring 78.

While the preferred embodiments and their modifications have been described for illustrative purpose only, it is to be understood that the invention may be embodied with various other changes and improvements, which may occur to those skilled in the art. cl NOMENCLATURE OF ELEMENTS

10: vehicular power transmitting system
54, 102: drum (second rotary member)
56, 88: carrier hub (first rotary member)
58, 90: frictional coupling portion
60: piston
66, 104: radially inner splined portion
68, 92: radially outer splined portion
70: friction discs
72: friction plates
94: cushion spring
C1, C1x, C1y: forward drive clutch (frictional coupling device)
a1, a2, b, e, f: spacing distance between adjacent spline teeth

What is claimed is:

1. A frictional coupling device of a vehicular power transmitting system, comprising:
a first rotary member disposed rotatably about an axis;
a second rotary member disposed rotatably about the axis;
a frictional coupling portion disposed between the first and second rotary members, and including a plurality of friction discs held in spline engagement with spline teeth of a radially outer splined portion formed on an outer circumferential surface of the first rotary member, and a plurality of friction plates held in spline engagement with spline teeth of a radially inner splined portion formed on an inner circumferential surface of the second rotary member, wherein the friction discs and the friction plates are alternately disposed adjacent to each other; and
a piston disposed movably in a direction of the axis toward the frictional coupling portion, to press the frictional coupling portion,
wherein a spacing distance between the adjacent spline teeth of the radially outer splined portion in a rotating direction thereof decreases along the direction of the axis in which the friction discs are brought into the spline engagement with the radially outer splined portion during assembling of the friction discs with respect to the first rotary member, and/or a spacing distance between the adjacent spline teeth of the radially inner splined portion in a rotating direction thereof decreases along the direction of the axis in which the friction plates are brought into the spline engagement with the radially inner splined portion during assembling of the friction plates with respect to the second rotary member.

2. The frictional coupling device according to claim 1, wherein the spacing distance between the adjacent spline teeth of the radially outer splined portion in the rotating direction thereof decreases along the direction of the axis in which the friction discs are brought into the spline engagement with the radially outer splined portion during assembling of the friction discs with respect to the first rotary member, and the direction in which the friction discs are axially brought into the spline engagement with the radially outer splined portion during assembling of the friction discs with respect to the first rotary member is the same as a direction in which the frictional coupling portion is pressed by the piston.

3. The frictional coupling device according to claim 2, further comprising a cushion spring which is disposed on one side of the frictional coupling portion remote from the piston, and which generates a biasing force for moving the frictional coupling portion toward the piston.

4. The frictional coupling device according to claim 3, wherein an amount of circumferential backlash in the rotating direction of the radially outer splined portion, which exists between the spline teeth of the radially outer splined portion and radially inner teeth of one of the friction discs which is located furthest from the piston in a direction of the axis, is determined to be zero, when the frictional coupling portion is placed in an engaged state.
